(19) United States
(12) Patent Application Publication
(10) Pub. No.: US 2008/0082235 A1
(43) Pub. Date: Apr. 3, 2008

(54) Vehicle body supporting system

(75) Inventor: Sachio NAKAMURA, Kanagawa (JP)

Correspondence Address: GREER, BURNS & CRAIN, 300 S WACKER DR, 25TH FLOOR, CHICAGO, IL, 60606, US

(73) Assignee: The Yokohama Rubber Co., Ltd., Tokyo (JP)

(21) Appl. No.: 11/904,675

(22) Filed: Sep. 28, 2007

(30) Foreign Application Priority Data
Sep. 29, 2006 (JP) 2006-269424

(51) Int. Cl. B60G 17/018

(52) U.S. Cl. 701/37; 267/140.11

(57) ABSTRACT

This vehicle body supporting system includes a gas passage that interconnects a gas chamber of one vehicle body supporting unit and a gas chamber of another vehicle body supporting unit and a gas passage opening/closing unit disposed on the gas passage. The gas passage opening/closing unit opens and closes the gas passage at a predetermined frequency corresponding to a frequency of reciprocative movement of transmission components of the vehicle body supporting units relative to the gas chambers.

### BACKGROUND OF THE INVENTION

1. Field of the Invention

The present invention relates to a vehicle body supporting system used for supporting a body of a vehicle.

2. Description of the Related Art

Suspensions of a vehicle or a railroad vehicle, or structures that need to be protected from vibrations or shocks are generally supported via a shock absorbing mechanism. U.S. Pat. No. 4,635,909 discloses an air spring. The air spring includes a piston that divides inside of a cylinder into two chambers. A passage that interconnects the two chambers is formed in the piston. A valve including two metal foils is arranged in the valve. With this arrangement, a force that has substantially the same frequency as the self-excitation vibration frequency of the valve is not transmitted to a sprung portion. When employing such an air spring in a vehicle, resonance amplitude can be suppressed by matching the resonance amplification frequency of sprung part of a vehicle with the self-excitation vibration frequency of the valve. Moreover, it is possible to avoid conveyance of an input, which is not to be conveyed to the vehicle, to the vehicle by matching the self-excitation vibration frequency of the valve with a frequency of an input.

The load on a suspension of a vehicle or a railroad vehicle is not always the same. For example, in case of a vehicle, the load varies depending upon the number of passengers or the weight of the luggage. A specific frequency of a vibration system varies with the load. The capacity to suppress the resonance amplitude decreases if the specific frequency of the vibration system varies.

### SUMMARY OF THE INVENTION

It is an object of the present invention to at least partially solve the problems in the conventional technology.

According to an aspect of the present invention, there is provided a vehicle body supporting system that is coupled to a vehicle body and a wheel of a vehicle to support the vehicle body with respect to the wheel. The vehicle body supporting system includes a plurality of supporting units each including a gas chamber filled with gas and a vibration inputting unit that conveys to the gas chamber vibrations from the vehicle body or the wheel by reciprocative movement relative to the gas chamber; a gas passage that interconnects a gas chamber of a first supporting unit from among the supporting units and a gas chamber of a second supporting unit from among of the supporting units; a gas passage opening/closing unit that is arranged in the gas passage for opening and closing the gas passage, wherein the gas passage opening/closing unit opens or closes the gas passage at a frequency that depends on a frequency of relative reciprocative movement of the vibration inputting unit to the gas chamber.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 depicts a vehicle body supporting system according to an embodiment of the present invention;

FIG. 2 is a block diagram of a control unit shown in FIG. 1;

FIG. 3 depicts a functional block diagram of a structure for executing Fourier analysis;

FIGS. 4 to 7 are graphs for explaining examples of controls performed in the vehicle body supporting system shown in FIG. 1;

FIGS. 8 to 11 are graphs for explaining other examples of controls performed in the vehicle body supporting system shown in FIG. 1;

FIG. 12 shows a configuration of a vehicle body supporting system for explaining an exemplary control of a vehicle body supporting system of this embodiment; and

FIG. 13 is an explanatory illustration showing motion of a vehicle.

### DETAILED DESCRIPTION OF THE PREFERRED EMBODIMENTS

Exemplary embodiments of the present invention will now be described in detail with reference to the accompanying drawings. The present invention is not limited to the embodiments explained below. Constituent elements of the embodiment include those that a person skilled in the art can easily arrive at or that are substantially equivalent, within the so-called equivalent scope.

An embodiment utilizes a characteristic that periodic opening and closing of a gas passage, that is connected to a gas chamber filled with gas such as air or nitrogen for supporting a load, for releasing a part of gas filled in the gas chamber to other gas chambers reduces spring rigidity of the gas chamber for an external force having a frequency equivalent to that of the opening and closing of the gas passage. Thus this embodiment has a characteristic that ensures an effect for intercepting vibration from a sprung mass (vehicle body mass) when a specific frequency of a vibration system changes. “Releasing” here means discharging gas out of a gas chamber if there is one gas chamber.

If the gas chamber for supporting a load (vehicle body mass) is one, the gas chamber is equipped with a gas passage opening/closing unit (e.g., an open/close valve), that is disposed on a gas passage, for discharging gas filled in the gas chamber to the outside, and releases a part of gas in the gas chamber to the outside by opening and closing the gas passage opening/closing unit at a predetermined frequency corresponding to a vibration frequency of a sprung mass (vehicle body mass).

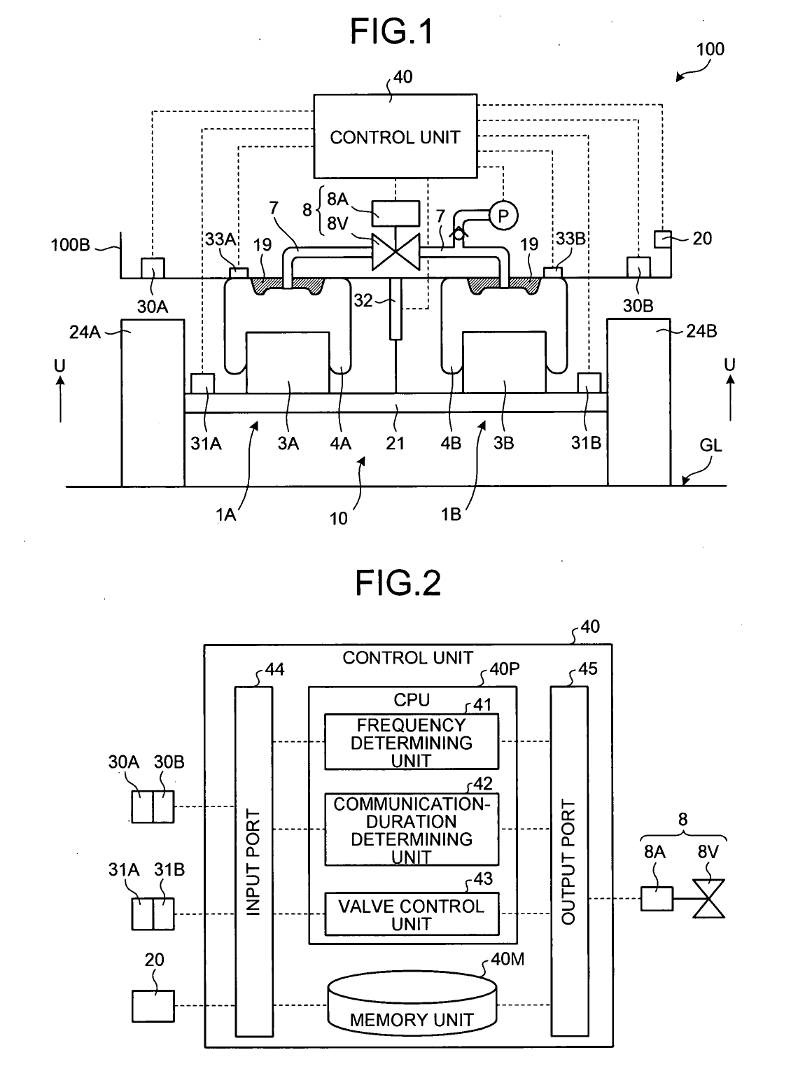

FIG. 1 is a schematic of a vehicle body supporting system 10 according to an embodiment of the present invention. The vehicle body supporting system 10 supports a vehicle 100. The vehicle body supporting system 10 includes vehicle body supporting units 1A and 1B between a vehicle body 1000B of the vehicle 100 and wheels 24A and 24B of the vehicle 100. The vehicle body supporting unit 1A includes a gas camber 4A and the vehicle body supporting unit 1B includes a gas camber 4B both filled with a gas. The vehicle body 100 is supported-by the pressure of the gas filled in the gas chambers 4A and 4B.

The vehicle body supporting units 1A and 1B function as absorbers, i.e., structures composed of springs and vibration damping units (e.g., dampers), of suspensions disposed on the vehicle 100. A structure sprung by the vehicle body supporting units 1A and 1B is the vehicle body 100B of the vehicle 100.

Because both the vehicle body supporting units 1A and 1B have the same configuration, the vehicle body supporting unit 1A will only be explained below. The vehicle body supporting unit 1A includes the gas chamber 4A filled with air (or nitrogen) and a transmission component 3A in contact with the gas chamber 4A. The gas chamber 4A made with an elastic component such as rubber or elastomer.

The transmission component 3A conveys vibrations of at least one-of the vehicle body 100B and the wheel 24A to the gas chamber 4A by oscillating relative to the gas chamber 4A. While the transmission component 3A directly conveys the vibrations from the wheel 24A to the gas chamber 4A, the vibrations from the vehicle body 100B are conveyed to the gas chamber 4A via a connecting portion between the vehicle body 100B and the gas chamber 4A.

The transmission components 3A and 3B are mounted on an axel 21. The wheels 24A and 24B are mounted on the axel 21. Inputs from the wheels 24A and 24B (force or vibration in the direction of arrows U of FIG. 1) are transmitted to the transmission components 3A and 3B via the axel 21, and then to the gas chambers 4A and 4B. The gas filled in the gas chambers 4A and 4B cushions the inputs being transmitted to the vehicle body 100B from the wheels 24A and 24B via the vehicle body supporting units 1A and 1B. Thus, the vehicle body supporting units 1A and 1B function as gas springs that absorb shocks received by the wheels 24A and 24B from a road surface GL and supports the weight of the vehicle body 100B. Although a simple rigid axel is shown in FIG. 1, the same theory holds good to suspensions independent for each wheel.

The gas chamber 4A and the gas chamber 4B are interconnected by a gas passage 7. A gas passage opening/closing unit 8 is arranged in the gas passage 7. The gas passage opening/closing unit 8 includes an open/close valve 8V and an actuator 8A for opening and closing the open/close valve 8V. The actuator can be a solenoid, a piezoelectric element, or an ultrasonic motor. A control unit 40 controls the operation of the actuator 8A.

Vehicle body acceleration sensors 30A and 30B are arranged on the vehicle body 100B. The vehicle body acceleration sensors 30A and 30B sense the acceleration of the vehicle body 100B, i.e., the acceleration of a sprung portion of the vehicle 100, in the orthogonal direction to the road surface GL. A vibration frequency of the sprung portion of the vehicle 100 can be calculated from the detected acceleration. Wheel acceleration sensors 31A and 31B are arranged on the axel 21 for detecting accelerations of the wheel 24A and 24B in the orthogonal direction to the road surface GL. Based on vibration acceleration of an unsprung portion of the vehicle 100 in the orthogonal direction to the road surface GL, that is obtained by detecting a motion of the axel 21 using the wheel acceleration sensors 31A and 31B, a vibration frequency of the unsprung portion of the vehicle 100 can be obtained. Thus, the vehicle body acceleration sensors 30A and 30B and the wheel acceleration sensors 31A and 31B function as vibration detecting units. To be more concrete, the vehicle body acceleration sensors 30A and 30B function as sprung vibration detecting units that detect vibration of a sprung portion of the vehicle 100, and the wheel acceleration sensors 31A and 31B function as unsprung vibration detecting units that detect vibration of an unsprung portion of the vehicle 100. A vehicle body angular velocity sensor 20 is arranged on the vehicle body 100B for detecting rolling vibration or pitching vibration of the vehicle body 100B. An angular acceleration sensor may be provided on the vehicle body 100B.

A stroke sensor 32 is mounted on the axel 21. The stroke sensor 32 detects height of the vehicle 100. The stroke sensor also detects strokes of the vehicle body supporting units 1A and 1B. This ensures maintenance of a constant height of the vehicle 100 by further filling gas into or discharging gas from the gas chambers 4A and 4B when height of the vehicle 100 is changed by change of number of passengers or a load.

Gas chamber pressure sensors 33A and 33B measure internal pressures of the gas chambers 4A and 4B. Although the pressure of an air spring is generally constant, the gas chamber pressure sensors 33A and 33B are useful for detecting sudden or huge changes in the pressure in case of emergency such as breakage of an air spring.

A pump P is arranged in the gas passage 7 for supplying air into the gas chambers 4A and 4B. If the stroke sensor 32 detects that the volumes of the airs in the gas chambers 4A and 4B are lower than or equal to a predetermined threshold, in which case the vehicle body supporting capacities of the vehicle body supporting devices 1A and 1B drops, the pump P:refills air in the gas chambers 4A and 4B. This ensures safety running of the vehicle 100 by maintaining capacities of the vehicle body supporting units 1A and 1B to support the vehicle body 100B.

The vehicle body supporting units 1A and 1B include stopper components 19 in positions on the side of installation to the vehicle body 100B, facing to the transmission components 3A and 3B. In case the gas in the gas chambers 4A and 4B leaks, and supporting of the sprung mass of the vehicle 100 by air pressure thereof is impossible, the stopper components 19 support the sprung mass. This ensures at-least low speed running of the vehicle 100 in case gas leakage from the gas chambers 4A and 4B accidentally happens because the stopper components 19 support a mass of the vehicle body 100B by directly contacting with the transmission components 3A and 3B.

In this manner, the gas chambers 4A and 4B are interconnected by the gas passage 7 in which gas filled therein passes through. The gas passage 7 has the open/close valve 8V configuring the gas passage opening/closing unit 8. This means that the open/close valve 8V is disposed between the gas chambers 4A and 4B. When the open/close valve is closed by the actuator 8A, the gas chambers 4A and 4B are isolated from each other, and movement of the gas is blocked between the gas chambers 4A and 4B. When the open/close valve 8V is opened by the actuator 8A, the gas chambers 4A and 4B communicate so that the gas can move between the gas chambers 4A and 4B through the gas passage 7.

The vehicle body supporting units 1A and 1B intercepts transmission of vibration having a notch frequency to the vehicle body 100B, functioning as a notch filter by reducing spring rigidity for vibration having the notch frequency. This ensures elimination of resonant amplification generated in a vibration system of the vehicle 100 and suppression of uncomfortable vibration being transmitted to the vehicle body 100B. Thus, the vehicle body supporting units 1A and 1B intercept vibration being transmitted to the vehicle body 100B. In other words, the vehicle body supporting units 1A and 1B function as vibration dampers.

A notch filter has a function to eliminate vibration of a specific frequency while allowing vibrations in other frequency bands passing through. The vehicle body supporting units 1A and 1B suppress vibration of a specific frequency (or plural dominant frequencies) by functioning as notch filters. This means that transmission of vibration of a specific frequency (or plural dominant frequencies) is intercepted between the wheels 24A and 24B (FIG. 1) and the vehicle body 100B.

A notch frequency is a frequency of vibration to be eliminated by a notch filter. For example, the notch frequency is supposed to be a specific frequency of a vibration system of the vehicle 100 including the vehicle body 100B and the vehicle body supporting units 1A and 1B. Because vibration of the vehicle body 100B is amplified by resonance phenomenon (resonant amplification) if vibration of the supposed frequency is input to the vehicle body 100B, such the vibration is desired to be transmitted as least as possible to the vehicle body 100B. Therefore, vibration of the specific frequency is vibration having a frequency desired to be intercepted from the vehicle body 100B. The vehicle body supporting units 1A and 1B of this embodiment can suppress resonant amplification phenomenon since vibration of the specific frequency is intercepted from the vehicle body 100B with a predetermined notch frequency equal to the specific frequency.

In order to reduce spring rigidity of the vehicle body supporting units 1A and 1B for vibration of a notch frequency, based on the principle of Fourier series, the gas passage opening/closing unit 8 can be opened and closed at not only the,notch frequency (a predetermined frequency corresponding to a frequency of oscillating movement of the transmission components 3A and 3B relative to the gas chambers 4A and 4B, respectively) but also at a higher frequency obtained by integral multiplication or a frequency obtained by integral division of the notch frequency. Hence the vehicle body supporting units 1A and 1B have a reduced transmissibility for the notch frequency and support a load maintaining a large transmissibility compared to the notch frequency for frequencies other than the notch frequency. This is a critical characteristic for supporting a static load (corresponding to a vibration frequency of 0). The control unit 40 is explained below.

FIG. 2 is a block diagram of the control unit 40. The control unit 40 includes a CPU (Central Processing Unit) 40P, a memory unit 40M, an input port 44, and an output port 45.

The CPU 40P includes a frequency determining unit 41, a communication-duration determining unit 42, and a valve control unit (gas passage opening/closing unit control unit) 43. These configure a portion that executes vibration control of this embodiment. The frequency determining unit 41, the communication-duration determining unit 42, and the valve control unit 43 are interconnected via the input port 44 and the output port 45. This configuration enables the frequency determining unit,41, the communication-duration determining unit 42, and the valve control unit 43 to mutually transmit and receive control data and to transmit commands to another side.

The CPU 40P and memory unit 40M are interconnected via the input port 44 and the output port 45. This configuration enables the control unit 40 to store data in the memory unit 40M and to utilize data, computer programs, etc. stored in the memory unit 40M.

The input port 44 is connected to the vehicle body acceleration sensors 30A and 30B, the wheel acceleration sensors 31A and 31B, the vehicle body angular velocity sensor 20, and other sensors to collect information necessary for controlling the vehicle body supporting system 10. Thus, the CPU 40 acquires information necessary for controlling the vehicle body supporting system 10. A control-target object, i.e., the actuator 8A that controls opening and closing of the open/close valve 8V configuring the gas passage opening/closing unit 8, is connected to the output port 45. This configuration ensures the CPU 40 to open and close the open/close valve 8V at a predetermined frequency based on output signals from the sensors.

Computer programs including a vibration control protocol and data are stored in the memory unit 40M. The memory unit 40M can be a volatile memory such as a RAM (Random Access Memory), a non-volatile memory such as a flash memory, or a combination thereof.

The computer program may be one that can attain the vibration control protocol of this embodiment in combination with a ready-installed program. The control unit 40 may be one that controls the frequency determining unit 41, the communication-duration determining unit 42, and the valve control unit 43 using specialized hardware instead of the computer program.

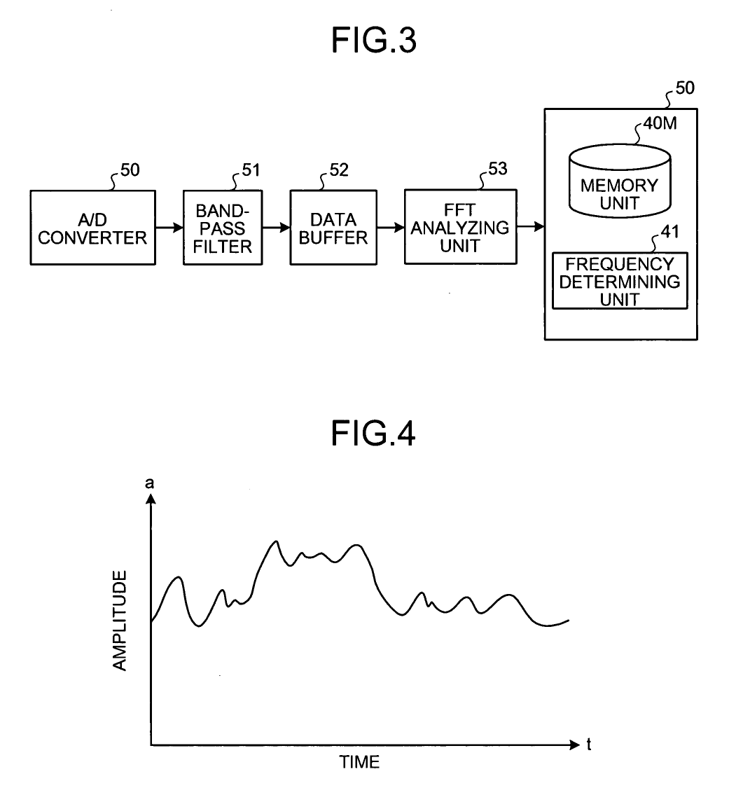

A first exemplary control of the vehicle body supporting system 10 is explained below. FIG. 3 is a functional block diagram of a structure that can execute Fourier analysis. FIGS. 4 to 7 are explanatory graphics of an exemplary vehicle body supporting system control of this embodiment. The following explanation describes about control of the vehicle body supporting system 10, demonstrating an example for suppressing vibration input from the vehicle body supporting unit 1A and being transmitted to the vehicle body 100B. The same explanation holds good for the vehicle body supporting unit 1B. In the present case, a frequency of vibration that is desired to be intercepted from the vehicle body 100B is set as a notch frequency, and the open/close valve 8V is opened and closed at the notch frequency or at a frequency obtained either by integral multiplication or by integral division of the notch frequency. Hence gas in the gas chamber 4A of the vehicle body supporting unit 1A goes in and out of the gas chamber 4B of another vehicle body supporting unit 1B at the notch frequency, and thereby spring rigidity of the vehicle body supporting unit 1A for the notch frequency is reduced. This attains the suppression of vibration having a frequency equal to the notch frequency and being transmitted to the vehicle body 100B via the vehicle body supporting unit 1A.

The frequency determining unit 41 determines a frequency (notch frequency) of vibration to be intercepted from the vehicle body 100B. The frequency determining unit 41 obtains vibration components of the vehicle body 100B based on the acceleration of the vehicle body 100B (acceleration of a sprung portion) acquired from the vehicle body angular velocity sensor 20, the vehicle body acceleration sensors 30A and 30B, or the wheel acceleration sensors 31A and 31B (see FIG. 1). Typical vibrations of the vehicle body 100B are shown in FIG. 4.

For providing passengers of the vehicle 100 with comfortable riding by suppressing vibration being transmitted to the vehicle body 100B from a load surface via the vehicle body supporting unit 1A, interception of vibrations that significantly affect the passengers is effective. A method based on the significance of power spectrum can be used for determining the significance of effects on passengers. This is because a high power component and low power component of vibration are considered to be a dominant component and a non-dominant component of the vibration, respectively. If the vibration to be suppressed is known (e.g., a specific frequency of a system including a sprung portion of the vehicle 100 and the vehicle body supporting system 10), vibration desired to be intercepted from the vehicle body 100B does not need to be determined. A power of vibration indicates intensity (power) of each frequency when input vibration is resolved into individual frequencies. Power of vibration is obtained by adding each squares of a sine-coefficient and a cosine-coefficient when Fourier-expanded.

In order to extract a high power spectrum, i.e., a dominant vibration component from vibration input momently, real time vibration analysis is preferable. The “real time vibration analysis” means not strict simultaneousness, but a process repeating a sequence to be completed within a predetermined time, in which plural vibration data (amplitude and power or energy) are sampled from acquired vibration at a predetermined time intervals, Fourier analysis is executed, and a vibration component with high power spectrum is extracted.

As shown in FIG. 3, vibration signals from the vehicle body acceleration sensors 30A and 30B (see FIG. 1) are converted from analogue signals into digital signals by an A/D (Analogue/Digital) converter 50. The digital vibration signals are sent to a band-pass filter 51, and only vibration components within a predetermined frequency band pass through.

In the case that vibration giving discomfort to passengers of the vehicle 100 is intercepted, a frequency band of problematic vibration including the frequency giving discomfort to the passengers and a resonant frequency for sprung and unsprung portions is known. The band-pass filter 51 that allows the frequency band to pass through is used for determining a frequency to be intercepted from the vehicle body 100B.

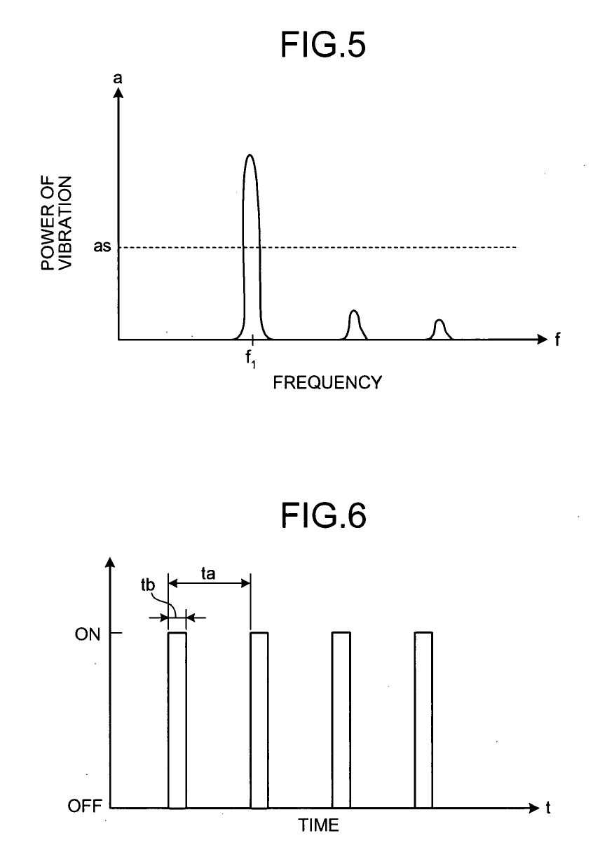

The vibration within the frequency band passing through the band-pass filter 51 is once stored in a data buffer 52. When the frequency determining unit 41 of the control unit 40 outputs a trigger signal to the data buffer 52 notifying the completion of analysis for a preceding data, vibration within the frequency band stored in the data buffer 52 is sent to an FFT (Fast Fourier Transform) analyzing unit 53 for Fourier analysis. FIG. 5 shows an exemplary result of Fourier analysis for vibration of the vehicle body 100B shown in FIG. 4.

Vibration within a determined frequency band that is transformed from time domain to frequency domain at the FFT analyzing unit 53 is stored in the memory unit 40M of the control unit 40. The frequency determining unit 41 determines a frequency to intercept based on a result of Fourier analysis, i.e., power spectrum stored in the memory unit 40M. In this embodiment, a frequency to be intercepted is a frequency of vibration having a power (or amplitude or energy) exceeding a predetermined threshold as, and f₁ is shown as an example in FIG. 5.

When the frequency determining unit 41 has determined a frequency to intercept, as described later, the control unit 40 executes a process to suppress a predetermined frequency being transmitted to the vehicle body 100B. When the execution of the process has completed, the frequency determining unit 41 transmits a command to the FFT analyzing unit 53 to acquire the next data from the data buffer 52 and to execute Fourier analysis. In this embodiment, a frequency of vibration giving a significant effect on passengers is detected by repeating the process, and the vehicle body supporting units 1A and one else are controlled so as to intercept the transmission thereof.

When a frequency to intercept has been determined, the frequency determining unit 41 sets a frequency to be intercepted or an integral multiplied value of the frequency as an opening/closing frequency fo of the gas passage opening/closing unit 8. FIG. 6 shows an example of an open-valve command pulse. As shown in FIG. 6, cycle of the open-valve command pulse is ta, and in the case that opening and closing are done at a determined frequency to be intercepted, fo=f₁=(1/ta). The communication-duration determining unit 42 determines width of open-valve command pulse tb (see FIG. 6) based on a supporting load of the vehicle body supporting units 1A and one else. The width of the open-valve command pulse tb is an open-valve duration of the open/close valve 8V, indicating communication duration of the gas passage 7 (hereinafter, referred to as open-valve duration). The open-valve duration tb should be changed depending upon a magnitude of power of vibration having a frequency to be intercepted. For example, when power of vibration having a frequency to be intercepted becomes larger, the open-valve duration tb is lengthened accordingly. This secures better interception of a notch frequency since a gain for a frequency to be intercepted can be set near 0. For another example, when a supporting load of the vehicle body supporting units 1A and one else becomes larger, the open-valve duration may be shortened accordingly.

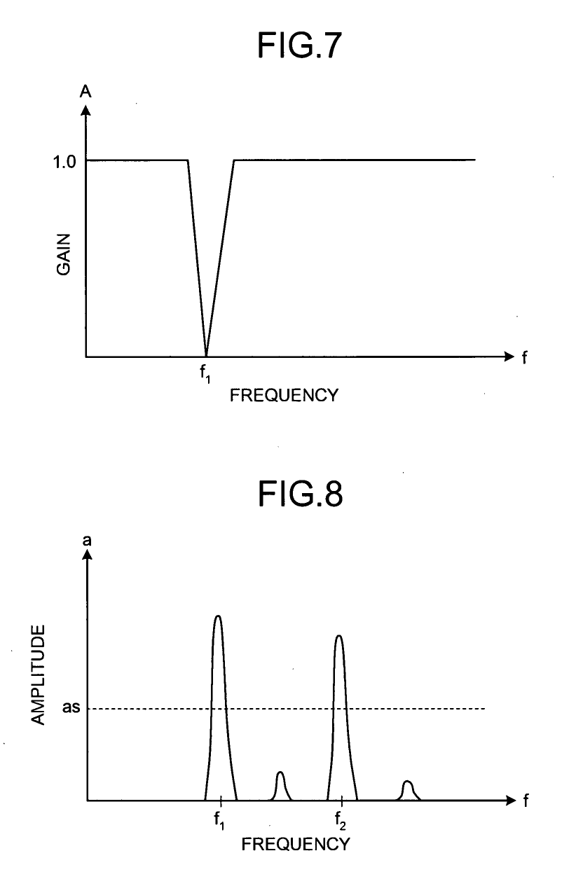

The valve control unit 43 outputs open-valve command pulse having an opening/closing frequency fo determined by the frequency determining unit 41 and an open-valve command pulse width of open-valve duration tb determined by the communication-duration determining unit 42 to the actuator 8A of the gas passage opening/closing unit 8. Thus, as shown in FIG. 7, the vehicle body supporting units 1A and one else function as frequency filters having gain of 0 for a frequency f₁ to be intercepted and gain of ca. 1.0 for other frequencies. This means that vibration having the frequency f₁ to be intercepted is suppressed by the vehicle body supporting units 1A and one else and hardly transmitted to the vehicle body 100B. Thereby vibration having frequency f₁ being transmitted to the vehicle body 100B is suppressed. Resonant amplification can be eliminated by setting a frequency f₁ to be intercepted at a resonant frequency of the vehicle body 100B supported by the vehicle body supporting units 1A and one else. A second exemplary control of the vehicle body supporting system 10 of this embodiment is explained below.

FIGS. 8 to 11 are explanatory graphics of another vehicle body supporting system control. The following explanation describes about control of the vehicle body supporting system 10 of the embodiment, demonstrating an example for suppressing plural vibrations, that are input from the vehicle body supporting unit 1A, being transmitted to the vehicle body 100B. The same explanation is applied to the vehicle body supporting unit 1B. In the present case, as there are plural (2 in this example) frequencies of vibration that are desired to be intercepted from the vehicle body 100B, plural notch frequencies are set corresponding to the frequencies.

The frequency determining unit 41 sets frequencies (notch frequencies) of vibrations to be intercepted from the vehicle body 100B. The frequency determining unit 41 Fourier-analyzes acquired vibration components of the vehicle body 100B. FIG. 8 shows an exemplary result of Fourier analysis. The frequency determining unit 41 determines notch frequencies based on results of Fourier analysis. In this embodiment, notch frequencies to be intercepted are frequencies of vibrations having a power (or amplitude or energy) exceeding a predetermined threshold as, and f₁ and f₂ are shown as examples in FIG. 8.

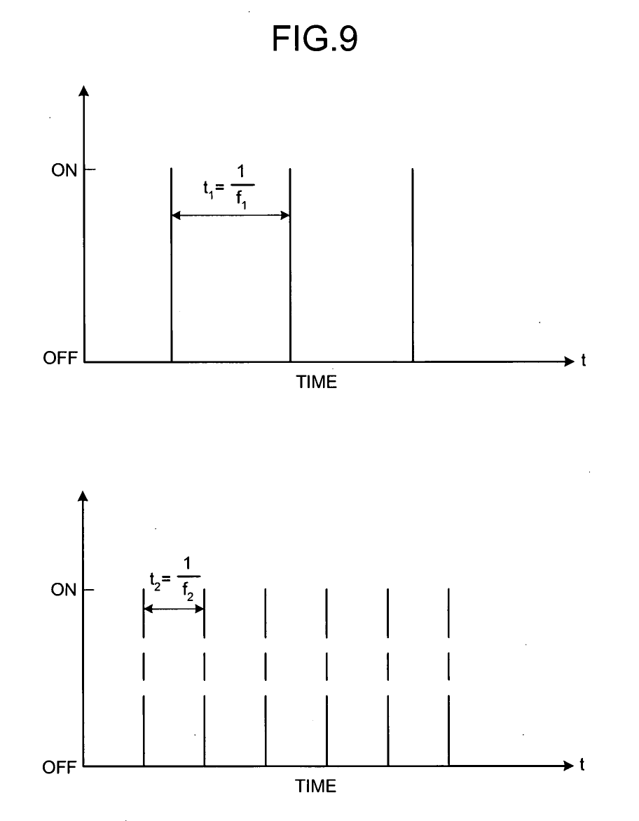

When a frequency to intercept has been determined, the frequency determining unit 41 sets open-valve command pulse for the gas,passage opening/closing unit 8. FIG. 9 is an example of open-valve command pulse, showing open-valve command pulse for the frequency f₁ in an upper graph and that for the frequency f₂ in an lower graph. As shown in FIG. 9, frequency of open-valve command pulse for the notch frequency f₁ is t₁, and f₁=(1/t₁). Frequency of open-valve command pulse for the notch frequency f₂ is t₂, and, f₂=(1/t₂).

In the case suppressing vibration components of plural notch frequencies, as shown in FIG. 10, the frequency determining unit 41 assigns an open-valve command pulse train by overlaying the open-valve command pulse for the notch frequency f₁ and that for the notch frequency f₂. In FIG. 10, solid lines are the open-valve command pulse for the notch frequency f₁ and dot-dashed lines are the open-valve command pulse for the notch frequency f₂.

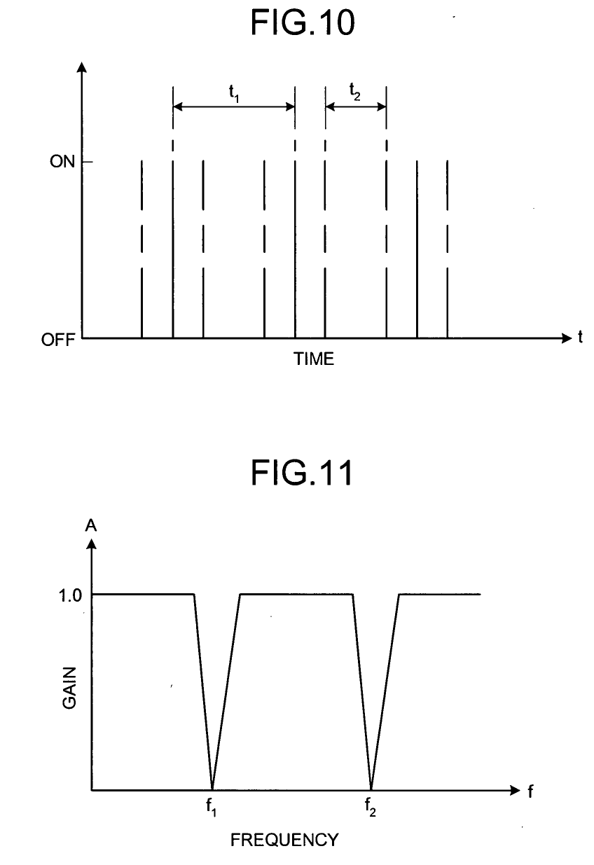

The valve control unit 43 outputs open-valve command pulse having an open-valve command pulse width of open-valve duration tb (see FIG. 6) determined by the communication-duration determining unit 42 to the actuator 8A of the gas passage opening/closing unit 8 using the open-valve command pulse train determined by the frequency determining unit 41. Thus, as shown in FIG. 11, the vehicle body supporting units 1A and one else function as frequency filters having gain of 0 for notch frequencies f₁ and f₂ and gain of 1.0 for other frequencies. This means that vibration having the notch frequencies f₁ and f₂ are suppressed by the vehicle body supporting units 1A and one else and hardly transmitted to the vehicle body 100B. Thereby vibrations having notch frequencies f₁ and f₂ being transmitted to the vehicle body 100B is suppressed.

Resonant amplification can be eliminated by setting a resonant frequency of a vibration system of the vehicle 100 for one of plural notch frequencies. While there is a problem that a capacity for suppressing vibration reduces in a high frequency range in an absorber comprising a spring and a damper, the vehicle body supporting unit 1A provided on the vehicle body supporting system 10 of this embodiment can intercept plural vibrations by setting plural notch frequencies. This ensures suppression of vibrations being transmitted to the vehicle body 100B for a wide frequency band.

While examples for suppressing vibration of a sprung portion of the vehicle 100 by the vehicle body supporting system 10 was explained in earlier description, the control by the vehicle body supporting system 10 of this embodiment can also be applied for vibration of an unsprung portion of the vehicle 100. In this case, vibration of unsprung portions of the vehicle 100 are detected by the wheel acceleration sensors 31A and one else instead of detecting vibration of vehicle body 100B (i.e., vibration of unsprung portion of the vehicle 100) by vehicle body acceleration sensors 30A and 30B. The gas passage opening/closing unit 8 is opened and closed at a notch frequency determined based on the detected vibration of the unsprung portions. As, thereby, vibration of the unsprung portions having a frequency that affects ride comfort is intercepted from the vehicle body 100B, the ride quality of the vehicle 100 is improved. Reduction of the followability of the wheels 24A and one else on the road surface GL can be minimized by setting a notch frequency at a frequency of unsprung portions that may reduce the followability of the wheels 24A and one else on the load surface GL.

In earlier examples, although a frequency of vibration to be suppressed is determined based on vibration of a sprung or an unsprung portion of the vehicle 100, that is detected by a vibration detecting unit, a frequency to be intercepted may be set at a constant value. For example, by selecting a specific frequency of a vibration system of the vehicle 100 as a frequency to be suppressed, the gas passage opening/closing unit 8 may be opened and closed constantly at a frequency corresponding to the specific frequency. Thereby control of the gas passage opening/closing unit 8 is simplified. In this case, since the specific frequency changes depending upon changes of number of passengers or a load of a vehicle, a frequency of vibration to be suppressed may be changed depending upon a change in the specific frequency detected by the vibration detecting unit. A third exemplary control of the vehicle body supporting system 10 of this embodiment is explained below.

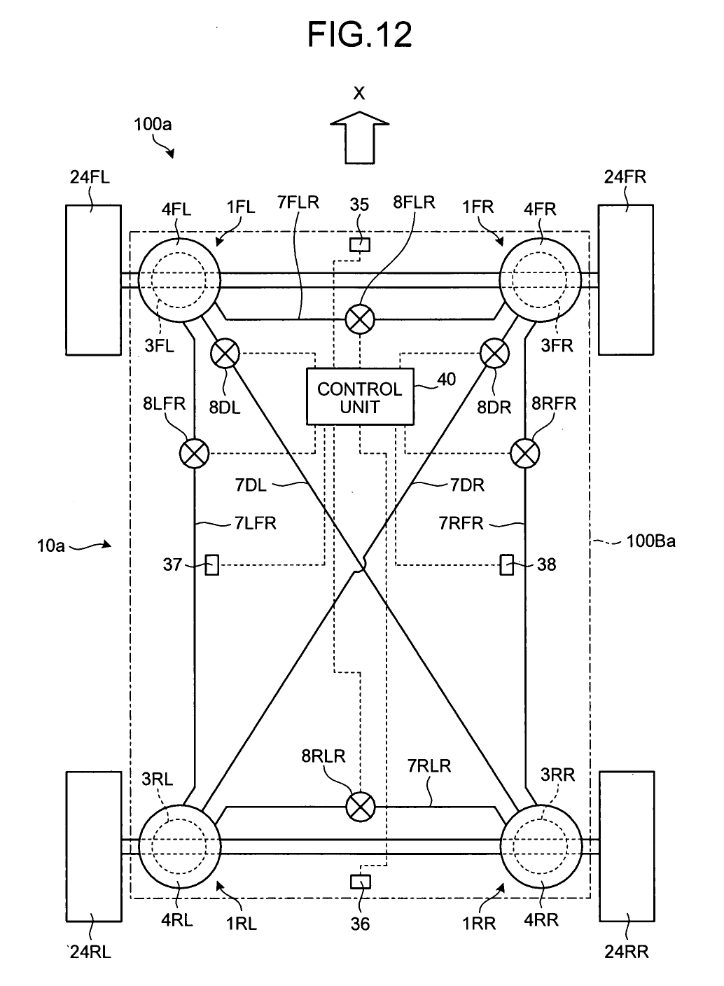

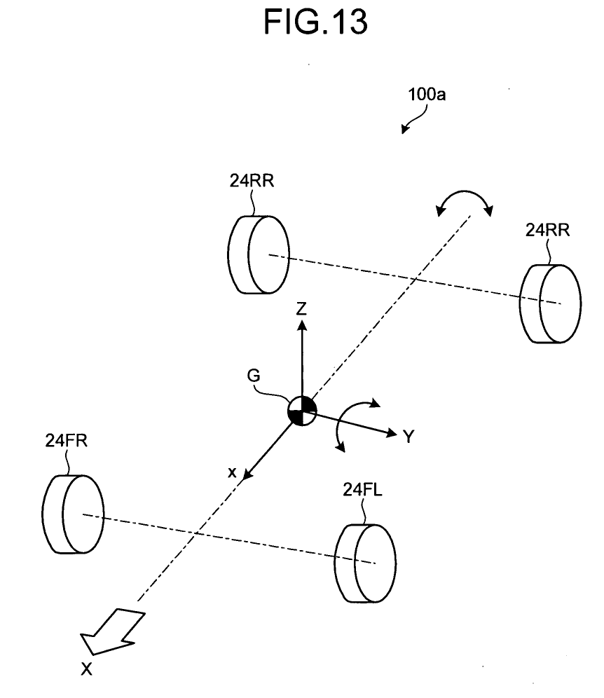

FIG. 12 shows a configuration of a vehicle body supporting system for explaining an exemplary control of a vehicle body supporting system of this embodiment. FIG. 13 is an explanatory drawing showing motion of a vehicle. This exemplary control explains an exemplary control for suppressing rotational vibrations such as pitching and rolling of a vehicle. Control of a vehicle body supporting system explained below is realized by the control unit 40 (see FIG. 2).

A vehicle 100a of FIG. 12 moves in a direction of an arrow X. Therefore, the direction of the arrow X of FIG. 12 is a front side of moving direction of the vehicle 100a. The vehicle 100a has a front-left wheel 24FL and a front-right wheel 24FR on the front side of the moving direction and a rear-left wheel 24RL and a rear-right wheel 24RR on the rear side of the moving direction. The front-left wheel 24FL, a rear-right wheel 24RR, and others are collectively referred to simply as wheels, as needed. Left and right are defined based on the front side of the moving direction of the vehicle 100a. As for definition of front and rear, front side of the moving direction of the vehicle 100a is front, and rear side of the moving direction of the vehicle 100a is rear.

A vehicle body 100Ba of the vehicle 100a of FIG. 12 is supported by a vehicle body supporting system 10a. The vehicle body supporting system 10a comprises a front left vehicle body supporting unit 1FL, a front right vehicle body supporting unit 1FR, a rear left vehicle body supporting unit 1RL, and a rear right vehicle body supporting unit 1RR. The front left vehicle body supporting unit 1FL, the front right vehicle body supporting unit 1FR, the rear left vehicle body supporting unit 1RL, and the rear right vehicle body supporting unit 1RR have a front left gas chamber 4FL, a front right gas chamber 4FR, a rear left gas chamber 4RL, and a rear right gas chamber 4RR, respectively. Vibrations from wheels are input to the front left gas chamber 4FL, the front right gas chamber 4FR, the rear left gas chamber 4RL, and the rear right gas chamber 4RR from a front left transmission component 3FL, a front right transmission component 3FR, a rear left transmission component 3RL, and a rear right transmission component 3RR, respectively.

In the vehicle body supporting system 10a, the front left gas chamber 4FL and the front right gas chamber 4FR are interconnected by a front gas passage 7FLR, and the rear left gas chamber 4RL and the rear right gas chamber 4RR are interconnected by a rear gas passage 7RLR. The front left gas chamber 4FL and the rear left gas chamber 4RL are interconnected by a left gas passage 7LFR, and the front right gas chamber 4FR and the rear right gas chamber 4RR are interconnected by a right gas passage 7RFR. The front left gas chamber 4FL and the rear right gas chamber 4RR are interconnected by a first diagonal gas passage 7DL, and the front right gas chamber 4FR and the rear left gas chamber 4RL are interconnected by a second diagonal gas passage 7DR.

A front gas passage opening/closing unit 8FLR, a rear gas passage opening/closing unit 8RLR, a left gas passage opening/closing unit 8LFR, and a right gas passage opening/closing unit 8RFR, are disposed on the front gas passage 7FLR, the rear gas passage 7RLR, the left gas passage 7LFR, and the right gas passage 7RFR, respectively. A first diagonal gas passage opening/closing unit 8DL and a second diagonal gas passage opening/closing unit 8DR are disposed on the first diagonal gas passage 7DL and the second diagonal gas passage 7DR, respectively. These gas passage opening/closing units are controlled by the control unit 40.

A front acceleration sensor 35 and a rear acceleration sensor 36 are disposed in the front and rear of the vehicle body 100Ba, respectively. A left acceleration sensor 37 and a right acceleration sensor 38 are disposed on the left and right sides of vehicle body 100Ba, respectively. The front acceleration sensor 35 and the rear acceleration sensor 36 detect pitching of the vehicle 100a, and the left acceleration sensor 37 and the right acceleration sensor 38 detect rolling of the vehicle 100a. In other words, the front acceleration sensor 35 and the rear acceleration sensor 36 function as a pitching detecting unit of the vehicle 100a, and the left acceleration sensor 37 and the right acceleration sensor 38 function as a rolling detecting unit of the vehicle 100a. For detecting pitching and rolling, detection of rotational movement such as pitching and rolling by an angular acceleration sensor or a vehicle body angular velocity sensor 20 placed in a position on the vehicle body 100Ba is more preferable.

The front acceleration sensor 35, the rear acceleration sensor 36, the left acceleration sensor 37 and the right acceleration sensor 38, and the angular acceleration sensor or the angular velocity sensor are connected to the control unit 40 to make up a configuration so that the control unit 40 is able to acquire signals detected by these acceleration sensors and the angular acceleration sensor or the angular velocity sensor to utilize for control. Pitching and rolling of the vehicle 100a may be detected simultaneously using a three-dimensional angular acceleration sensor instead of the sensors. In this case, the three-dimensional angular acceleration sensor functions as a pitching/rolling detecting unit of the vehicle 100a.

As shown in FIG. 13, an axis penetrating a center of gravity G of the vehicle 100a and in parallel with a moving direction of the vehicle 100a, an axis penetrating a center of gravity G of the vehicle 100a and in parallel with a direction orthogonal to a contact surface of the vehicle 100a, and an axis penetrating a center of gravity G of the vehicle 100a and orthogonal to both the former axes are defined as x-axis, y-axis, and z-axis, respectively. In this case, rotation of the vehicle 100a about the y-axis is referred to as pitching, and rotation of the vehicle 100a about the x-axis is referred to as rolling. -When the vehicle body supporting system 10a suppresses pitching of the vehicle 100a, the frequency determining unit 41 of the control unit 40 acquires acceleration information from the front acceleration sensor 35 and the rear acceleration sensor 36. More desirably, pitching angular vibration should be acquired using an angular acceleration sensor or the vehicle body angular velocity sensor 20. The frequency determining unit 41 computes a frequency of pitching (pitching frequency) of the vehicle 100a based on the acceleration or angular acceleration acquired and sets this as a notch frequency. The frequency determining unit 41 determines a timing for opening and closing (hereinafter, referred to as open/close timing) the left gas passage opening/closing unit 8LFR and the right gas passage opening/closing unit 8RFR based on the set notch frequency. As a notch frequency, a frequency having energy larger than or equal to a predetermined vibration energy may be extracted, and in the case that plural notch frequencies exist, the open/close timing may be determined by superimposing them (same for the followings).

The communication-duration determining unit 42 of the control unit 40 determines width tb of an open-valve command pulse (see FIG. 6) for at least one of the left gas passage opening/closing unit 8LFR and the right gas passage opening/closing unit 8RFR based on supporting loads of the front left vehicle body supporting unit 1FL, the rear right vehicle body supporting unit 1RR, etc., or based on power of a dominant frequency of a rotational vibration in pitching. The valve control unit 43-of the control unit 40 opens and closes at least one of the left gas passage opening/closing-unit 8LFR and the right gas passage opening/closing unit 8RFR with both an open/close timing determined by the frequency determining unit 41 and an open-valve command pulse width determined by the communication-duration determining unit 42. Hence spring rigidities of the front left vehicle body supporting unit 1FL and/or the rear right vehicle body supporting unit 1RR are reduced for the pitching frequency, and thereby gain of these vehicle body supporting units become near 0 for the pitching frequency. Vibration of the pitching frequency is intercepted from the vehicle body 100Ba of the vehicle 100a consequently, and pitching of the vehicle 100a is suppressed. Control for suppressing rolling of the vehicle 100a is explained below.

In the case suppressing rolling of the vehicle 100a by the vehicle body supporting system 10a, the frequency determining unit 41 of the control unit 40 acquires rolling angular vibrations using the left acceleration sensor 37 and the right acceleration sensor 38 or the vehicle body angular velocity sensor 20. The frequency determining unit 41 computes a dominant frequency of rolling (dominant rolling frequency) of the vehicle 100a based on the acceleration acquired and sets this as a notch frequency. The frequency determining unit 41 determines a timing for opening and closing (hereinafter, referred to as open/close timing) at least one of the front gas passage opening/closing unit 8FLR and the rear gas passage opening/closing unit 8RLR based on the set notch frequency.

The communication-duration determining unit 42 of the control unit 40 determines width tb of an open-valve command pulse (see FIG. 6) for each vehicle body supporting unit based on supporting loads of the front left vehicle body supporting unit 1FL, the rear right vehicle body supporting unit 1RR, etc., or based on power of a dominant frequency of rolling angular vibration. The valve control unit 43 of the control unit 40 opens and closes at least one of the front gas passage opening/closing unit 8FLR and the rear gas passage opening/closing unit 8RLR with both an open/close timing determined by the frequency determining unit 41 and an open-valve command pulse width determined by the communication-duration determining unit 42. Hence spring rigidities of the front left vehicle body supporting unit 1FL, the rear right vehicle body supporting unit 1RR, etc. are reduced for the rolling frequency, and thereby gain of these vehicle body supporting-units become near 0 for the rolling frequency. Vibration of the rolling frequency is intercepted from the vehicle body 100Ba of the vehicle 100a consequently, and rolling of the vehicle 100a is suppressed.

For suppressing vibration in a diagonal direction of the vehicle 100a, a frequency of the vibration is set as a notch frequency. For example, the first diagonal gas passage opening/closing unit 8DL disposed on the first diagonal gas passage 7DL or the second diagonal gas passage opening/closing unit 8DR disposed on the second diagonal gas passage 7DR is opened and closed at the notch frequency. Thus the vehicle body supporting system 10a ensures the improvement of both stability of the vehicle 100a and comfortableness for passengers by suppressing pitching and rolling of the vehicle 100a.

A vehicle body supporting system of this embodiment comprises a gas chamber filled with gas such as air or nitrogen and a vibration inputting unit that inputs vibration to the gas chamber by its oscillating movement relative to the gas chamber, and the inputting unit opens and closes a gas passage connected to the gas chambers at predetermined notch frequencies corresponding to a frequency of oscillating movement of the vibration inputting unit relative to the gas chamber. By this configuration, vibration of the notch frequency is intercepted by vehicle body supporting units provided on a vehicle body supporting system and is hardly transmitted to the vehicle body. When a specific frequency of a vibration system that consists of mass of the vehicle body supporting units and mass supported thereby changes, the vehicle body supporting system ensures intercepting effect of vibration to the supported mass while supporting a static load by changing a frequency for opening and closing the gas passage connected to the gas chambers in response to changes in vibration characteristics. By setting a notch frequency based on vibration of unsprung portions of a vehicle, reduction of the followability of wheels on the road surface GL can be minimized for example.

A vehicle body supporting system according to the present invention ensures a suppressing effect of vibration to a vehicle body while supporting a load of the vehicle body when a specific frequency of a vibration system that consists of masses of vehicle body supporting units and the vehicle body supported thereby changes.

A vehicle body supporting system of the present invention comprises a gas chamber filled with gas and a vehicle body supporting unit including a vibration inputting unit that inputs vibration to the gas chamber by its oscillating movement relative to the gas chamber, and a gas passage interconnecting gas chambers of different vehicle body supporting units is opened and closed at a predetermined frequency corresponding to a frequency of oscillating movement of the vibration inputting unit relative to the gas chamber. By this configuration, the vehicle body supporting system functions as a frequency filter having a gain of 0 for the predetermined frequency and a gain of ca. 1.0 for other frequencies. This means that vibration of the predetermined frequency is intercepted by the vehicle body supporting unit of the vehicle body supporting system and hardly transmitted to a vehicle body supported by the vehicle body supporting system. When a specific frequency of a vibration system that consists of masses of the vehicle body supporting units and the vehicle body supported thereby changes, the vehicle body supporting system ensures an intercepting effect of vibration to a supported vehicle body while supporting a static load by changing a frequency for opening and closing the gas passage connected to the gas chambers in response to the change of the specific frequency.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle body supporting system that is coupled to a vehicle body and a wheel of a vehicle to support the vehicle body with respect to the wheel, the vehicle body supporting system comprising:
a plurality of supporting units each including a gas chamber filled with gas and a vibration inputting unit that conveys to the gas chamber vibrations from the vehicle body or the wheel by reciprocative movement relative to the gas chamber;
a gas passage that interconnects a gas chamber of a first supporting unit from among the supporting units and a gas chamber of a second supporting unit from among of the supporting units;
a gas passage opening/closing unit that is arranged in the gas passage for opening and closing the gas passage, wherein the gas passage opening/closing unit opens or closes the gas passage at a frequency that depends on a frequency of relative reciprocative movement of the vibration inputting unit to the gas chamber.

2. The vehicle body supporting system according to claim 1, further comprising:
a vibration detecting unit arranged on the vehicle body and-detects various vibrations of at least one of a sprung portion and an unsprung portion of the vehicle;
a calculating unit that calculates a power of each of the vibrations detected by the vibration detecting unit; and
a selecting unit that selects suppression target vibrations from among the vibrations detected by the vibration detecting unit based on magnitude of the power calculated by the calculating unit, the suppression target vibrations being vibrations of the vehicle body or the wheel that are not to be conveyed to the gas chamber, wherein
the gas passage opening/closing unit opens and closes the gas passage at a frequency of the suppression target vibrations, or at a frequency obtained either by integral multiplication or by integral division of a frequency of the suppression target vibrations.

3. The vehicle body supporting system according to claim 2, wherein the gas passage opening/closing unit adjusts a ratio between an opening duration and a closing duration of the gas passage depending upon power intensity of the suppression target vibrations.

4. The vehicle body supporting system according to claim 2, wherein the selecting unit selects a plurality of vibrations having higher power intensity than a certain power as the suppression target vibrations.

5. The vehicle body supporting system according to claim 4, wherein the gas passage opening/closing unit adjusts a ratio between an opening duration and a closing duration of the gas passage depending upon power intensity of each of the suppression target vibrations.

6. The vehicle body supporting system according to claim 1, wherein
the first supporting unit is one that supports a front wheel of the vehicle and the second supporting unit is one that supports a rear wheel of the vehicle, and
the gas passage opening/closing unit opens and closes the gas passage based on a pitching frequency of the vehicle.

7. The vehicle body supporting system according to claim 1, wherein
the first supporting unit is one that supports a left wheel of the vehicle and the second supporting unit is one that supports a right wheel of the vehicle, and
the gas passage opening/closing unit opens and closes the gas passage based on a-rolling frequency of the vehicle.
